(19) United States
(12) Patent Application Publication
(10) Pub. No.: US 2011/0123781 A1
(43) Pub. Date: May 26, 2011

(54) Corrugated fiberboard for bullet-resistant vest

(76) Inventor: Kuo-tzu Chiu, Tianjin (CN)

(21) Appl. No.: 12/623,459

(22) Filed: Nov. 23, 2009

(51) Int. Cl. B32B 3/28

(52) U.S. Cl. 428/182

(57) ABSTRACT

A corrugated fiberboard includes a top linerboard comprising an upper layer of PE and a lower layer of paper; a corrugated sheet comprising a plurality of layers of corrugation trough support, each of the layers of corrugation trough support having a crush resistance in a range of 90 g/m² to 180 g/m²; and a base linerboard comprising a plurality of layers formed of kraft paper. The corrugated fiberboard is light weight and has a maximum crush resistance of about 180 g/m² to 360 g/m² to be suitable as the material for manufacturing a type of cost effective bullet-resistant vest which is capable of absorbing the impact from handgun-fired projectiles.

### BACKGROUND OF THE INVENTION

1. Field of Invention

The invention relates to corrugated fiberboards and more particularly to such a corrugated fiberboard having improved crush resistance for being used as the manufacturing material of bullet-resistant vests.

2. Description of Related Art

One type of conventional corrugated fiberboard has a maximum crush resistance of about 180 g/m². Such type of corrugated fiberboard is appropriate to be used as, for example, containers for storing articles rather than as soft bullet-resistant vests. That is, the maximum crush resistance of about 180 g/m² is only the minimum requirement of an acceptable bullet-resistant vest. Thus, the need for improvement still exists.

### SUMMARY OF THE INVENTION

It is therefore one object of the invention to provide a corrugated fiberboard for bullet-resistant vest.

The above and other objects, features and advantages of the invention will become apparent from the following detailed description taken with the accompanying drawings.

### BRIEF DESCRIPTION OF THE DRAWINGS

FIG. 1 is a longitudinal sectional view of a corrugated fiberboard for bullet-resistant vest according to the invention;

FIG. 2 is a longitudinal sectional view of the top linerboard;

FIG. 3 is a longitudinal sectional view of the corrugated sheet; and

FIG. 4 is a longitudinal sectional view of the base linerboard.

### DETAILED DESCRIPTION OF THE INVENTION

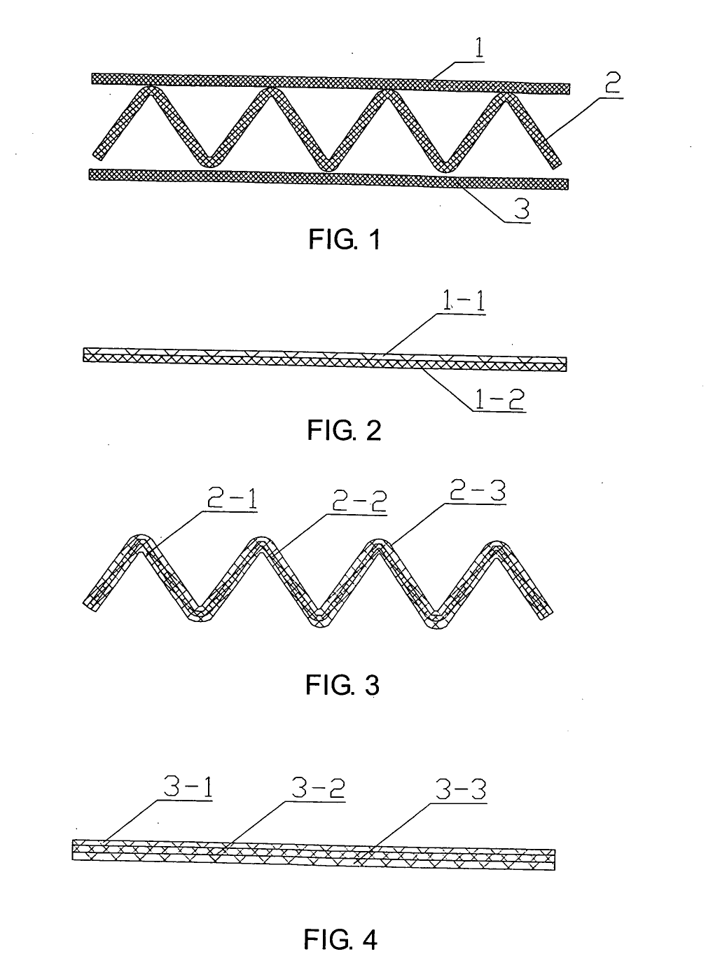

Referring to FIGS. 1 to 4, a corrugated fiberboard for bullet-resistant vest in accordance with the invention comprises the following components as discussed in detail below.

A top linerboard 1 comprises an upper layer 1-1 of polyethylene (PE) and a lower layer 1-2 of paper.

A corrugated sheet 2 comprises a top layer 2-1 of corrugation trough support, an intermediate layer 2-2 of corrugation trough support, and a bottom layer 2-3 of corrugation trough support. Each of the layers 2-1, 2-2, and 2-3 has a maximum crush resistance of about 90 g/m² to 180 g/m².

A base linerboard 3 comprises a top layer 3-1, an intermediate layer 3-2, and a bottom layer 3-3. Each of the layers 3-1, 3-2, and 3-3 is made of kraft paper or the like.

The layers 1-1 and 1-2 are formed together by coating an adhesive of polyethylene and polypropylene on them and then pressing together.

Similarly, the layers 2-1, 2-2, and 2-3 are formed together by coating the adhesive on them and then pressing together.

Likewise, the layers 3-1, 3-2, and 3-3 are formed together by coating the adhesive on them and then pressing together.

As to preparation of the adhesive, it comprises the steps of adding particles of polypropylene and particles of polyethylene into a tank; mixing same; and heating the tank to a temperature in a range of 280° C. to 330° C. until the particles of polypropylene and polyethylene are molten to form the finished adhesive in which weight percentage of the polypropylene is about 70% to 85% and weight percentage of the polyethylene is about 15% to 30% respectively.

The top linerboard 1, the corrugated sheet 2, and the base linerboard 3 are pressed together in a manner well known in the art of corrugated fiberboard manufacturing processes.

It is envisaged by the invention that the finished corrugated fiberboard (i.e., enhanced corrugated fiberboard) is light weight and has a maximum crush resistance of about 180 g/m² to 360 g/m² to be suitable as the material for manufacturing a type of cost effective bullet-resistant vest which is capable of absorbing the impact from handgun-fired projectiles.

While the invention herein disclosed has been described by means of specific embodiments, numerous modifications and variations could be made thereto by those skilled in the art without departing from the scope and spirit of the invention set forth in the claims.

What is claimed is:

1. A corrugated fiberboard for manufacturing bullet-resistant vests comprising:
a top linerboard comprising an upper layer of polyethylene (PE) and a lower layer of paper;
a corrugated sheet comprising a plurality of layers of corrugation trough support, each of the layers of corrugation trough support having a crush resistance in a range of 90 g/m² to 180 g/m²; and
a base linerboard comprising a plurality of layers formed of paper element.

2. The corrugated fiberboard of claim 1, wherein the paper element is kraft paper.

3. The corrugated fiberboard of claim 1, wherein the layers of corrugation trough support comprise three layers.

4. The corrugated fiberboard of claim 1, wherein the layers of the base linerboard comprise three layers.
